(19) United States
(12) Patent Application Publication
(10) Pub. No.: US 2015/0146632 A1
(43) Pub. Date: May 28, 2015

(54) PRIORITIZATION FOR UPLINK TRANSMISSIONS IN CASE OF HYBRID AUTOMATIC REPEAT REQUEST FEEDEBACK REPETITION

(71) Applicant: NOKIA SOLUTIONS AND NETWORKS OY, Espoo (FI)

(72) Inventors: Chunli Wu, Beijing (CN); Benoist Pierre Sebire, Tokyo (JP)

(21) Appl. No.: 14/400,103

(22) PCT Filed: May 10, 2013
(86) PCT No.: PCT/IB2013/053806

§ 371 Date: Nov. 10, 2014

Related U.S. Application Data
(60) Provisional application No. 61/645,136, filed on May 10, 2012.

(51) Int. Cl. H04L 1/18; H04W 72/12

(52) U.S. Cl. CPC H04L 1/1825; H04W 72/12
USPC 370/329

(57) ABSTRACT

Communication systems, such as long term evolution, can benefit from enhancements to hybrid automatic repeat request (HARQ) handling. For example, certain LTE systems can benefit from prioritization of uplink (UL) transmissions in case of HARQ feedback repetition, A method can include, when a random access channel preamble collides with ACK/NACK, prioritizing the preamble over ACK/NACK, The method can be performed regardless of repetition being configured or not. Another method can include, when a dedicated scheduling request or a msg3 collides with an ACK/NACK repetition, conditionally prioritizing the dedicated scheduling request or the msg3 transmission.

### BACKGROUND

This application is related to and claims the priority of U.S. Provisional Patent Application No. 61/645,136 filed May 10, 2012, which is hereby incorporated herein by reference in its entirety.

### BACKGROUND

1. Field

Communication systems, such as long term evolution, can benefit from enhancements to hybrid automatic repeat request (HARQ) handling. For example, certain LTE systems can benefit from prioritization of uplink (UL) transmissions in case of HARQ feedback repetition.

2. Description of the Related Art

In LTE, when acknowledgment (ACK)/ negative acknowledgement (NACK) repetition is not configured, ACK/NACK for downlink (DL) can be transmitted on a physical uplink control channel (PUCCH) or piggybacked on a physical uplink shared channel (PUSCH), so that DL and uplink (UL) can both have continuous transmissions without interrupting each other.

However, when ACK/NACK repetition is configured, ACK/NACK can conventionally only be transmitted on PUCCH and no other UL signal can be sent in the same transmission time interval (TTI). As a result, UL and DL would conventionally have to work in a time division multiplexed (TDM) manner where some TTIs are used to send HARQ feedback for DL and some TTIs are used for UL data transmission. When there is no UL data, “continuous” DL transmission still may be possible with several TTIs HARQ feedback provided for one DL transmission.

Third generation partnership project (3GPP) technical specification (TS) 36213, which is hereby incorporated herein by reference in its entirety, explains that if ACK/NACK repetition is enabled, when a physical downlink shared channel (PDSCH) transmission in subframe n−4 is intended for the UE for which ACK/NACK response is expected, and if the UE is not repeating the transmission of any ACK/NACK in subframe n corresponding to a PDSCH transmission in subframes n−N_{ANRep}−3, . . . , n−5, the UE can have the following requirements. The UE can transmit only the ACK/NACK response, corresponding to the detected PDSCH transmission in subframe on PUCCH in subframes n, n+1, . . . , n+N_{ANRep}−1 and the UE cannot transmit any other signal in those subframes. Moreover, the UE cannot transmit any ACK/NACK response repetitions corresponding to any detected PDSCH transmission in subframes n−3, . . . , n+N_{ANRep}−5.

When there is UL data arrival, a scheduling request (SR) is sent to request an UL grant, via dedicated scheduling request (D-SR) on PUCCH or random access channel (RACH) if DSR is not configured. Moreover, sr-ProhibitTimer is started after sending the D-SR, while waiting for the evolved Node B (eNB) to respond, to avoid excessively frequent D-SR transmissions.

When D-SR collides with ACK/NACK, if ACK/NACK repetition is not configured, D-SR is multiplexed with ACK/NACK for PUCCH format 3 or the SR PUCCH resources are used for ACK/NACK when there is a positive SR. If ACK/NACK repetition is configured, D-SR is conventionally blocked.

For RACH, UE behavior is not specified for the case of preamble transmission colliding with ACK/NACK if ACK/NACK repetition is not configured. When ACK/NACK repetition is configured, both preamble and msg3 transmission are prevented when the preamble collides with ACK/NACK. Msg3 can carry a radio resource control (RRC) connection request or measurement report message with C-RNTI MAC CE from the user equipment. It can be a response to msg2 sent by the base station.

Thus, the behavior currently specified for ACK/NACK repetition leads to the situation where DL data communication can blocks the uplink. This can delay a measurement report, when the UE detects a condition for handover, typically at cell edge, which is where ACK/NAK repetition may also be desired. It is difficult for a conventional eNB scheduler to avoid such collisions, as the conventional eNB cannot predict when the UE would have UL data to send.

One approach may be to avoid restarting sr-ProhibitTimer and not to increase the DR retx number (SR_COUNTER) if the DSR is not being able to be sent in the physically layer because of the collision with the ACK/NACK repetition. However, this approach does not avoid DL blocking UL if the eNB continuously schedules DL of the UE. Moreover, altering SR_COUNTER can actually block a potential RACH procedure, delaying even further a possible measurement report.

### SUMMARY

According to a first embodiment, a method can include, when a random access channel preamble collides with ACK/NACK, prioritizing the preamble over ACK/NACK.

According to a second embodiment, a method can include, when a dedicated scheduling request or a msg3 collides with an ACK/NACK, prioritizing the dedicated scheduling request or the msg3 transmission.

According to a third embodiment, a method can include ignoring a possible downlink assignment during a random access channel procedure.

According to fourth through sixth embodiments respectively, a non-transitory computer-readable medium encoded with instructions that, when executed in hardware, perform a process. The process can include the method according to respectively the first through third embodiments.

According to a seventh embodiment, an apparatus can include at least one processor and at least one memory including computer program instructions. The at least one memory and the computer program instructions can be configured to, with the at least one processor, cause the apparatus at least to, when a random access channel preamble collides with ACK/NACK, prioritize the preamble over ACK/NACK.

According to an eighth embodiment, an apparatus can include at least one processor and at least one memory including computer program instructions. The at least one memory and the computer program instructions can be configured to, with the at least one processor, cause the apparatus at least to, when a dedicated scheduling request or a msg3 collides with an ACK/NACK, prioritize the dedicated scheduling request or the msg3 transmission.

According to a ninth embodiment, an apparatus can include at least one processor and at least one memory including computer program instructions. The at least one memory and the computer program instructions can be configured to, with the at least one processor, cause the apparatus at least to ignore a possible downlink assignment during a random access channel procedure.

According to a tenth embodiment, an apparatus can include transmission means for communicating on a random access channel. The apparatus can also include prioritizing means for, when a random access channel preamble collides with ACK/NACK, prioritizing the preamble over ACK/NACK.

According to an eleventh embodiment, an apparatus can include transmission means for communicating on a random access channel. The apparatus can also include prioritizing means for, when a dedicated scheduling request or a msg3 collides with an ACK/NACK, prioritizing the dedicated scheduling request or the msg3 transmission.

According to a twelfth embodiment, an apparatus can include transmission means for communicating on a random access channel. The apparatus can also include prioritizing means for, ignoring a possible downlink assignment during a random access channel procedure.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a system according to certain embodiments.

### DETAILED DESCRIPTION

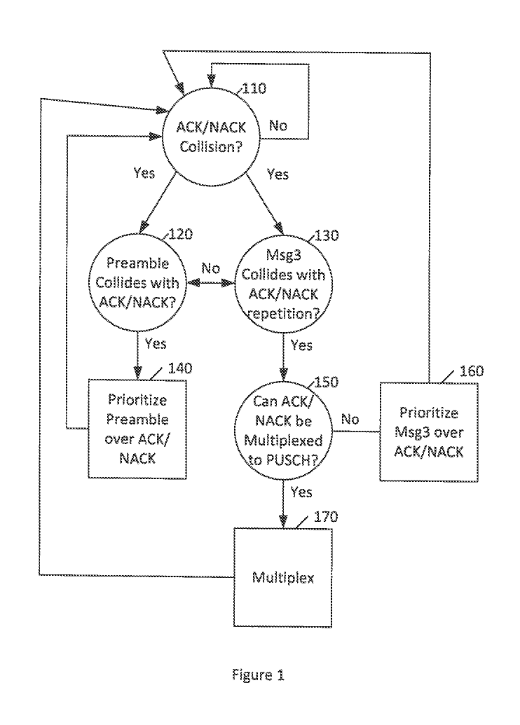

Various techniques can be used to permit a random access channel (RACH) procedure to be initiated. FIG. 1 illustrates a method according to certain embodiments. As shown in FIG. 1, at 110, a system, such as a user equipment (UE), can be monitoring for ACK/NACK collision. As long as there is no collision, the system can continue to monitor. If there is a collision, the system can determine, at 120, whether the preamble collides with. ACK/NACK regardless of whether repetition is involved or the system can determine, at 130, whether msg3 collides with an ACK/NACK repetition. When a preamble collides with ACK/NACK, with repetition or not, the system can, at 140, prioritize the preamble over ACK/NACK. When a msg3 collides with ACK/NACK repetition, at 150, the system can determine whether ACK/NACK can be multiplexed to a physical uplink shared channel (PUSCH). If not, the system can, at 160, prioritize msg3 transmission. However, if ACK/NACK can be multiplexed into the PUSCH, the system can employ such multiplexing at 170. D-SR can similarly be prioritized, if possible, when it cannot be sent together with ACK/NACK. It is also possible that DSR can be sent together with ACK/NACK repetition for the TTIs that collision occurs, following the same rule as when ACK/NACK repetition is not configured, such as by using the SR PUCCH resource for SR+ACK/NACK for PUCCH format 1a/1b and multiplexing the SR with ACK/NACK for PUCCH format 3.

Another alternative is that possible DL assignment(s) are ignored during the RACH procedure, for example for the time period after preamble transmission until msg3 transmission. Thus in general certain embodiments may either not indicate ACK/NACK to the physical layer (PHY) when ACK/NACK collides with D-SR/preamble/msg3, or the physical layer can perform the prioritization.

Certain embodiments can avoid a situation in which D-SR/preamble/msg3 is blocked in the physical layer while the SR/RACH procedure, such as the preamble reattempting with power ramping, is still ongoing in medium access control (MAC). Such blocking can delay handover (HO) and/or leads to random access (RA) failure.

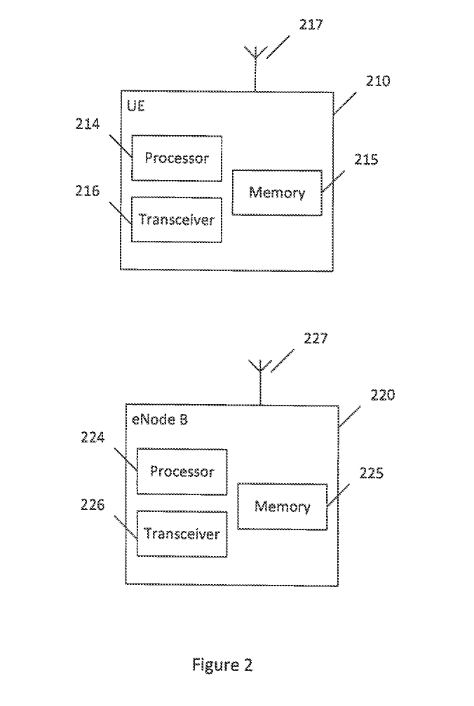

FIG. 2 illustrates a system according to certain embodiments of the invention. In one embodiment, a system may include two devices, such as, for example, UE 210 and eNB 220. Each of these devices may include at least one processor, respectively indicated as 214 and 224. At least one memory is provided in each device, and indicated as 215 and 225, respectively. The memory may include computer program instructions or computer code contained therein. Transceivers 216 and 226 are provided, and each device may also include an antenna, respectively illustrated as 217 and 227. Other configurations of these devices, for example, may be provided. For example, UE 210 and eNB 220 may be configured for wired communication, rather than wireless communication, and in such a case antennas 217 and 227 would illustrate any form of communication hardware, without requiring a conventional antenna.

Transceivers 216 and 226 can each, independently, be a transmitter, a receiver, or both a transmitter and a receiver, or a unit or device that is configured both for transmission and reception.

Processors 214 and 224 can be embodied by any computational or data processing device, such as a central processing unit (CPU), application specific integrated circuit (ASIC), or comparable device. The processors can be implemented as a single controller, or a plurality of controllers or processors.

Memories 215 and 225 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate therefrom. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 210 and eNB 220, to perform any of the processes described above (see, for example, FIG. 1). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 2 illustrates a system including a UE and an eNB, embodiments of the invention may be applicable to other configurations, and configurations involving additional elements.

A method, according to certain embodiments, includes, when a random access channel preamble collides with ACK/NACK, prioritizing the preamble over ACK/NACK.

The method can be performed regardless of repetition being configured or not.

A method, in certain embodiments, includes, when a dedicated scheduling request or a msg3 collides with an ACK/NACK repetition, conditionally prioritizing the dedicated scheduling request or the msg3 transmission.

In the method, a condition of the conditionally prioritizing can be if ACK/NACK repetition cannot be multiplexed into a shared channel.

The shared channel can be the physical uplink shared channel.

According to certain embodiments, a method includes ignoring a possible downlink assignment during a random access channel procedure.

The above methods can be performed by a user equipment.

The above methods can be combined with one another.

A non-transitory computer-readable medium is, according to certain embodiments, encoded with instructions that, when executed in hardware, perform any of the above-described methods.

An apparatus, according to certain embodiments, includes, at least one processor and at least one memory including computer program instructions. The at least one memory and the computer program instructions are configured to, with the at least one processor, cause the apparatus at least to, when a random access channel preamble collides with ACK/NACK, prioritize the preamble over ACK/NACK.

The at least one memory and the computer program instructions are configured to, with the at least one processor, cause the apparatus at least to perform the prioritization regardless of repetition being configured or not.

An apparatus, in certain embodiments, includes, at least one processor and at least one memory including computer program instructions. The at least one memory and the computer program instructions are configured to, with the at least one processor, cause the apparatus at least to, when a dedicated scheduling request or a msg3 collides with an ACK/NACK repetition, conditionally prioritize the dedicated scheduling request or the msg3 transmission.

The at least one memory and the computer program instructions are configured to, with the at least one processor, cause the apparatus at least to, perform the conditionally prioritizing upon a condition that the ACK/NACK repetition cannot be multiplexed into a shared channel.

The shared channel can be the physical uplink shared channel.

According to certain embodiments, an apparatus includes at least one processor and at least one memory including computer program instructions. The at least one memory and the computer program instructions are configured to, with the at least one processor, cause the apparatus at least to, ignore a possible downlink assignment during a random access channel procedure.

An apparatus, according to certain embodiments, includes, transmission means for communicating on a random access channel. The apparatus also includes prioritizing means for, when a random access channel preamble collides with ACK/NACK, prioritizing the preamble over ACK/NACK.

The apparatus can perform the function regardless of repetition being configured or not.

An apparatus, in certain embodiments, includes transmission means for communicating on a random access channel. The apparatus also includes prioritizing means for, when a dedicated scheduling request or a msg3 collides with an ACK/NACK repetition, conditionally prioritizing the dedicated scheduling request or the msg3 transmission.

In the apparatus, a condition of the conditionally prioritizing can be if ACK/NACK repetition cannot be multiplexed into a shared channel.

The shared channel can be the physical uplink shared channel.

According to certain embodiments, an apparatus includes transmission means for communicating on a random access channel. The apparatus also includes prioritizing means for, ignoring a possible downlink assignment during a random access channel procedure.

Each of the above apparatuses can comprise a user equipment.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
when a random access channel preamble collides with ACK/NACK, prioritizing the preamble over ACK/NACK.

2. The method of claim 1, wherein the method is performed regardless of ACK/NACK repetition being configured or not.

3. A method, comprising:
when a dedicated scheduling request or a msg3 collides with an ACK/NACK, prioritizing the dedicated scheduling request or the msg3 transmission.

4. The method of claim 3, wherein the prioritizing is conditionally prioritizing if ACK/NACK cannot be multiplexed into a shared channel or dedicated scheduling request.

5. The method of claim 1, the method is performed when ACK/NACK repetition is configured.

6. The method of claim 3, the method is performed regardless of whether ACK/NACK repetition is configured or not.

7. The method of claim 4, wherein the shared channel comprises a physical uplink shared channel.

8. A method, comprising:
ignoring a possible downlink assignment during a random access channel procedure.

9. The method of claim 1, wherein the method is performed by a user equipment.

10. A non-transitory computer-readable medium encoded with instructions that, when executed in hardware, perform a process, wherein the process comprises the method according to claim 1.

11. An apparatus, comprising:
at least one processor; and
at least one memory including computer program instructions,
wherein the at least one memory and the computer program instructions are configured to, with the at least one processor, cause the apparatus at least to
when a random access channel preamble collides with ACK/NACK, prioritize the preamble over ACK/NACK.

12. The apparatus of claim 11, wherein the at least one memory and the computer program instructions are configured to, with the at least one processor, cause the apparatus at least to perform the prioritization regardless of ACK/NACK repetition being configured or not.

13. An apparatus, comprising:
at least one processor; and
at least one memory including computer program instructions,
wherein the at least one memory and the computer program instructions are configured to, with the at least one processor, cause the apparatus at least to,
when a dedicated scheduling request or a msg3 collides with an ACK/NACK, prioritize the dedicated scheduling request or the msg3 transmission.

14. The apparatus of claim 13, wherein the at least one memory and the computer program instructions are configured to, with the at least one processor, cause the apparatus at least to, prioritize conditionally if the ACK/NACK cannot be multiplexed into a shared channel or a dedicated scheduling request.

15. The apparatus of claim 11, wherein the at least one memory and the computer program instructions are configured to, with the at least one processor, cause the apparatus at least to prioritize when ACK/NACK repetition is configured.

16. The apparatus of claim 13, wherein the at least one memory and the computer program instructions are configured to, with the at least one processor, cause the apparatus at least to prioritize regardless of whether ACK/NACK repetition is configured or not.

17. The apparatus of claim 14, wherein the shared channel comprises the physical uplink shared channel.

18. An apparatus, comprising:
at least one processor; and
at least one memory including computer program instructions,
wherein the at least one memory and the computer program instructions are configured to, with the at least one processor, cause the apparatus at least to
ignore a possible downlink assignment during a random access channel procedure.

19.-24. (canceled)

25. The apparatus of claim 11, wherein the apparatus comprises a user equipment.
